(19) United States
(12) Patent Application Publication
(10) Pub. No.: US 2006/0256752 A1
(43) Pub. Date: Nov. 16, 2006

(54) System and method for call handoff from packet data wireless network to circuit switched wireless network

(75) Inventors: Sven Anders Borje Svensson, San Diego, CA (US); Erik Colban, San Diego, CA (US); Martin Hans Renschler, San Diego, CA (US); Ralf Keller, Wurselen (DE); George Foti, Dollard Des Ormeaux (CA)

Correspondence Address: COATS & BENNETT, PLLC, P O BOX 5, RALEIGH, NC, 27602, US

(73) Assignee: Telefonaktiebolaget LM Ericsson (publ)

(21) Appl. No.: 11/321,166

(22) Filed: Dec. 29, 2005

Related U.S. Application Data
(60) Provisional application No. 60/679,404, filed on May 10, 2005.

(51) Int. Cl. H04Q 7/00

(52) U.S. Cl. 370/331

(57) ABSTRACT

A Handoff (HO) Function facilitates the handoff of a hybrid Access Terminal/Mobile Terminal (AT/MT) from a packet data wireless network to a circuit switched wireless network, while the AT/MT is engaged in a call with another party through an IMS network. The HO Function subscribes to dialogue events for the AT/MT, and is thus aware of all relative network parameters. When a handoff is required, the HO Function generates all signaling necessary to include into the IMS network user plane, a media gateway connected to the circuit switched MSC, and to redirect the other party to the media gateway. The HO Function then generates signaling to hand the AT/MT off to the circuit switched network, which then communicates through the MSC to the media gateway. The home network of the AT/MT need not be involved in, or even aware of, the handoff.

### RELATED APPLICATIONS

This application claims the benefit of U.S. Provisional Patent Application 60/679,404 filed May 10, 2005, which is incorporated herein by reference.

### BACKGROUND

The present invention relates generally to the field of communication networks and in particular to a system and method for handing off a call from a packet data wireless network to a circuit switched wireless network.

Early wireless communication networks were circuit switched, with a communication channel dedicated to each call. A network “channel” may comprise a particular transmission frequency, a time slot in a Time Division Multiple Access (TDMA) system, a unique spreading code in a Code Division Multiple Access (CDMA) system, or the like. Circuit switched wireless networks are widely deployed and extensively used, communicating both voice and digital data to and from mobile users using mobile terminals (MT).

With the rapid growth of the Internet, technological advances in packet data networks have yielded network architectures, protocols, and equipment that route data in autonomous units (“packets”) using shared channels with high speed, low latency, and high network resource utilization efficiency. Recently, dedicated packet data wireless communication networks have been developed and deployed that route packetized voice (such as Voice over IP, or VoIP) and data packets to and from mobile users using mobile access terminals (AT). The distinguishing characteristic of such packet data wireless networks, as opposed to circuit switched wireless networks with packet data transmission capabilities, is that packet data for multiple users is transmitted over one or more shared, high bandwidth channels, rather than a dedicated channel being assigned to each user (or call). One example of such a dedicated packet data wireless communication network is the CDMA 1×EV-DO standard. The development, deployment, and use of packet data a wireless networks is expected to increase.

As with any cellular wireless network, mobility management is required to maintain communications with mobile MTs or ATs as users move throughout different geographic areas. Mobile Assisted Hand-Off (MAHO) is a well-known element of mobility management. In MAHO, mobile terminals report channel conditions, desired data rates, pilot strengths signals from neighboring radio base stations, and the like to a serving base station, which, using this information as well as the relative loading among neighboring base stations, determines if, when, and to which base station to hand off a mobile terminal.

One problem with some deployed packet data wireless networks (such as 1×EV-DO) is that the shared packet data channels are transmitted in a different frequency band than are the dedicated traffic channels in a corresponding circuit switched wireless network, and a mobile unit cannot operate on both frequencies at the same time. It may be possible to hand off a VoIP call on a packet data wireless network to, e.g., the packet data services available on a circuit switched wireless network if the proper service options were set in the standards to support the required Quality of Service (QoS) needed for the voice call, and if the networks support concurrent voice/data services. Because these conditions are not generally met by deployed wireless networks, a need exists in the art for a system and method to facilitate handoff of a VoIP call in a packet data wireless network to a conventional circuit switched wireless network for hybrid mobile units (AT/MT) that are capable of communications with both networks (e.g., in both frequency bands).

### SUMMARY

According to one or more embodiments of the present invention, an inventive network node referred to as a Handoff (HO) Function facilitates the handoff of a hybrid Access Terminal/Mobile Terminal (AT/MT) from a packet data wireless network to a circuit switched wireless network, while the AT/MT is engaged in a call with another party through an IMS network. The HO Function subscribes to dialogue events for the AT/MT, and is thus aware of all relative network parameters. When a handoff is required, the HO Function generates all signaling necessary to include into the IMS network user plane, a media gateway connected to the circuit switched MSC, and to redirect the other party to the media gateway. The HO Function then generates signaling to hand the AT/MT off to the circuit switched network, which then communicates through the MSC to the media gateway. The home network of the AT/MT need not be involved in, or even aware of, the handoff.

In particular, when the packet data wireless network indicates that a handoff to a circuit switched wireless network is likely, the HO Function initiates SIP messages to include the media gateway (with a trunk to the MSC) in the IMS network user plane. When the packet data wireless network requests the handoff, the HO Function forwards an emulated circuit switched hard handoff request to the MSC, and receives handoff radio parameters in return. The HO Function sends the radio parameters to the AT/MT in a handoff command, and activates the media gateway by SIP messaging. The AT/MT then tunes to the circuit switched wireless network, and continues its call with the other party through the MSC and the media gateway. In this manner, handoff from the packet data wireless network to the circuit switched wireless network is accomplished in accordance with the circuit switched 3GPP/3GPP2 standard as well as the IMS architectural principles.

One embodiment relates to a method of handing off a roaming, hybrid AT/MT from a packet data wireless network to a circuit switched wireless network. The call state of the hybrid AT/MT is monitored within the roaming network. The hybrid AT/MT is handed off from the packet data wireless network to the circuit switched wireless network without support from the home network of the hybrid AT/MT.

Another embodiment relates to a method of facilitating the handoff of a hybrid AT/MT, engaged in a call with another party in an IMS network, from a packet data wireless network to a circuit switched wireless network. A handoff indication is received from the packet data network. A Media Gateway (MGw) having a dedicated connection to a MSC in the circuit switched wireless network is added to the IMS user plane between the hybrid AT/MT and other party. An emulated hard handoff request is sent to the MSC, identifying the MGw connection. Radio parameters for the circuit switched wireless network are received from the MSC. The circuit switched wireless network radio parameters are forwarded in a handoff command to the hybrid AT/MT, and the other party is directed to connect to the MGw.

Another embodiment relates to a HO Function with signaling connections to a packet data wireless network, a circuit switched wireless network, and an IMS network, the HO Function operative to facilitate the handoff of a hybrid AT/MT from the packet data wireless network to the circuit switched wireless network. The HO Function includes a IMS interface module exchanging SIP messages with the IMS network to alter the IMS network user plane connectivity. The HO Function also includes a wireless network handoff translation module receiving a handoff request from, and outputting circuit switched radio parameters to, the packet data wireless network, and outputting an emulated circuit switched handoff request to, and receiving handoff radio parameters from, the circuit switched wireless network.

Another embodiment relates to a communication network operative to hand off a hybrid AT/MT from a packet data wireless network to a circuit switched wireless network during a call with another party. The network includes a MGw connected to the circuit switched wireless network via a dedicated handoff trunk and connected to one or more packet data networks by a packet data link, the MGw operative to translate media between packet data and circuit switched formats under the control of a MGCF. The network also includes a HO Function having signaling connections to the MGCF, the packet data wireless network, the circuit switched wireless network, and at least one IMS network.

### BRIEF DESCRIPTION OF DRAWINGS

FIG. 1 is a functional network diagram of a VoIP call between one AT and a hybrid AT/MT in a roaming packet data wireless network.

FIG. 2 is a functional network diagram of the voice call of FIG. 1 following handoff of the hybrid AT/MT from the packet data wireless network to a circuit switched wireless network.

FIG. 3 is a functional network diagram of a voice call between the PSTN and a hybrid AT/MT in a roaming packet data wireless network.

FIG. 4 is a functional network diagram of the voice call of FIG. 5 following handoff of the hybrid AT/MT from the packet data wireless network to a circuit switched wireless network.

FIGS. 5A-5B are a call signal diagram.

FIGS. 6A-6E are a flow diagram describing the signal diagram of FIGS. 5.

FIG. 7 is a functional block diagram of a Handoff Function network node.

### DETAILED DESCRIPTION

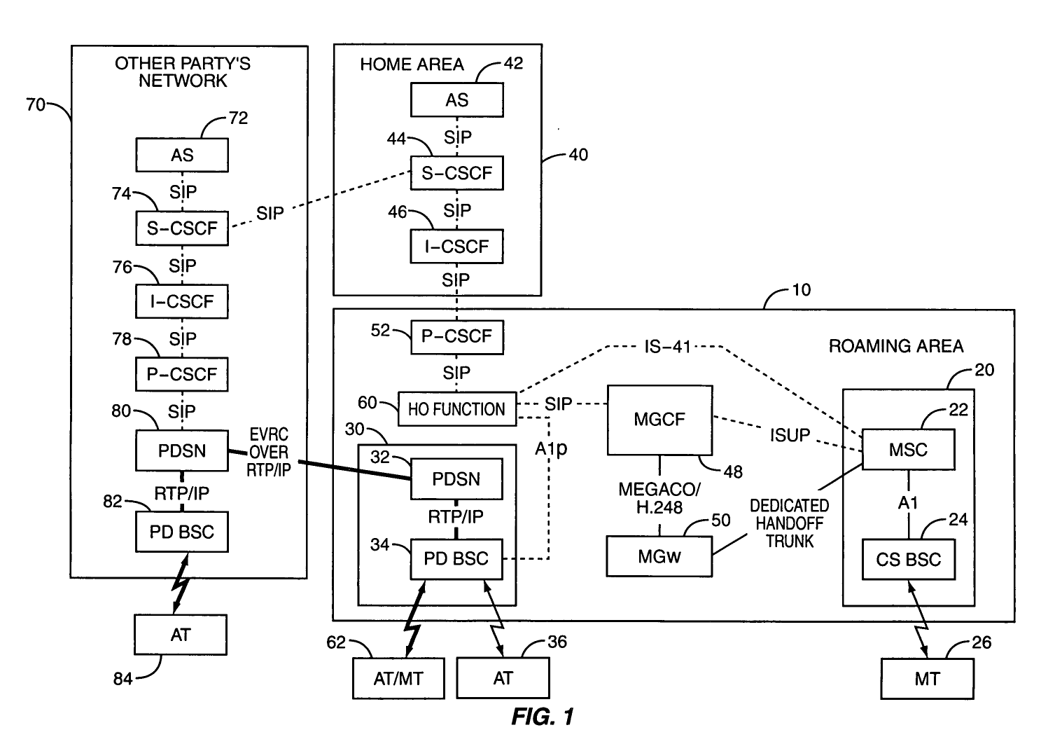

FIG. 1 depicts a representative wireless communication network 10, connected to a home area of an IP Multimedia Subsystem (IMS) network 40. The integrated wireless network 10 comprises a circuit switched wireless network 20, a packet data wireless network 30, a Handoff (HO) Function 60, and IMS network nodes 48, 50, 52 described below.

The circuit switched wireless network 20 comprises a Mobile Switching Center (MSC) 22 connected to one or more circuit switched Base Station Controllers (CS BSC) 24 providing communication services to one or more mobile terminals (MT) 26. The MSC 22 routes voice and data over circuit switched network connections between the CS BSC 24 and numerous other network nodes (not shown) such as for example the Public Switched Telephone Network (PSTN). The CS BSC 24 includes or controls one or more radio base stations or base station transceivers (not shown) that include the transceiver resources necessary to support radio communication with MTs 26, such as modulators/demodulators, baseband processors, radio frequency (RF) power amplifiers, antennas, and the like.

The packet data wireless network 30 comprises a Packet Data Switching Node (PDSN) 32 connected to one or more packet data Base Station Controllers (PD BSC) 34 providing packet data communication services to one or more access terminals (AT) 36. The PDSN 32 routes data packets between the PD BSC 34 and other packet data networks, such as an IMS network 70. The PD BSC 34 includes or controls one or more radio base stations similar to the CS BSC 24, but provides packet data communications on shared, high-bandwidth channels to ATs 36, and, as depicted in FIG. 1, a hybrid AT/MT 62 operative to communicate with both the packet data wireless network 30 and the circuit switched wireless network 20.

The packet data wireless network 30 is connected to an IMS network 40. The IMS is a general-purpose, open industry standard for voice and multimedia communications over packet-based IP networks 40. The IMS network 40 includes one or more Application Servers (AS) 42 providing various services (audio and video broadcast or streaming, push-to-talk, videoconferencing, games, filesharing, e-mail, and the like). Communications between nodes within the IMS network 40 utilize the Session Initiation Protocol (SIP). SIP is a signaling protocol for Internet conferencing, telephony, presence, events notification, instant messaging, and the like. SIP uses a long-term stable identifier, the SIP Universal Resource Indicator (URI). The IMS network 40 is the home network area for the hybrid AT/MT 62.

The AS 42 is connected to a Serving-Call Session Control Function (S-CSCF) 44. The S-CSCF 44 initiates, manages, and terminates multimedia sessions between IMS 40 terminals. The S-CSCF 44 may be connected to an optional Interrogating-CSCF (I-CSCF) 46. The I-CSCF 48 is a SIP proxy located at the edge of an administrative domain. The I-CSCF (or S-CSCF if a I-CSCF is not present) is connected to a Proxy-CSCF (P-CSCF) 52. The P-CSCF 50 is a SIP proxy that is the first point of contact to the IMS 40 from the hybrid AT/MT 62 through the packet data wireless network 30.

FIG. 1 depicts a roaming hybrid AT/MT 62 is being served by the wireless packet data network 30. That is, the PDSN 32 is not the home PDSN for the hybrid AT/MT 62. The roaming, hybrid AT/MT 62 is engaged in a Voice over IP (VoIP) call with an AT 84, which is being served by a PD BSC 82. In general, the PD BSC 82 may be part of a separate IMS network 70, as depicted in FIG. 1, and referred to herein as the other party's network. The other party may alternatively connect to the hybrid AT/MT 62 through the same network (i.e., the packet data wireless network 30). The IMS network 70 comprises a AS 72, a S-CSCF 74, an optional I-CSCF 76, a P-CSCF 78, a PDSN 80, and the PD BSC 82, with functionality as previously described. The voice bearer path between the AT 84 and the hybrid AT/MT 62 is depicted by heavy solid lines. In particular, coded voice packets from the AT 84 are received by PD BSC 82, routed through the PDSN 80, and forwarded to the PDSN 32. The coded voice packets may for example comprise Enhanced Variable Rate CODEC (EVRC) encoded voice packets, and may be transmitted via Real-time Transport Protocol (RTP) or Internet Protocol (IP). The voice packets are then routed to the PD BSC 34, and transmitted to the hybrid AT/MT 62. Voice packets in the opposite direction follow the reverse path.

As the hybrid AT/MT 62 moves physically further from the radio transceiver resources of the PD BSC 34, the hybrid AT/MT 62 indicates poor channel conditions to the PD BSC 34, such as by requesting a lower data rate via a Data Rate Control (DRC) index. When the hybrid AT/MT 62 reports sufficiently poor channel conditions, the PD BSC 34 determines it must hand the hybrid AT/MT 62 off to another wireless network node.

If the packet data wireless network 30 is of limited geographic extent, and the hybrid AT/MT 62 is at the edge of its service area, it is likely that the hybrid AT/MT 62 may be served by a circuit switched wireless network 20, which are more widely deployed. However, the hybrid AT/MT 62 cannot simultaneously operate in the different frequency bands utilized by the packet data wireless network 30 and the circuit switched wireless network 20. CDMA soft handoff is thus impossible.

According to one or more embodiments of the present invention, the handoff of a hybrid AT/MT 62 from the packet data wireless network 30 to the circuit switched wireless network 20 is facilitated by a Handoff (HO) Function 60. The HO Function 60 is an inventive network node that facilitates handoff by initiating and coordinating various network signaling, as described more fully herein. As will be readily apparent to those of skill in the art, the HO Function 60 may be logically considered a part of the packet data wireless network 30, the circuit switched wireless network 20, or as a node of the IMS network 40. Similarly, the circuits and/or software that implement the HO Function 60 functionality may physically reside within the PDSN 32, the MSC 22, or any other network node, as required or desired. In particular, the HO Function 60 and the MGCF 48 may be combined and/or co-located. Each PD BSC 34 is associated with precisely one HO Function 60; however, a single HO Function 60 may serve a plurality of PD BSCs 34.

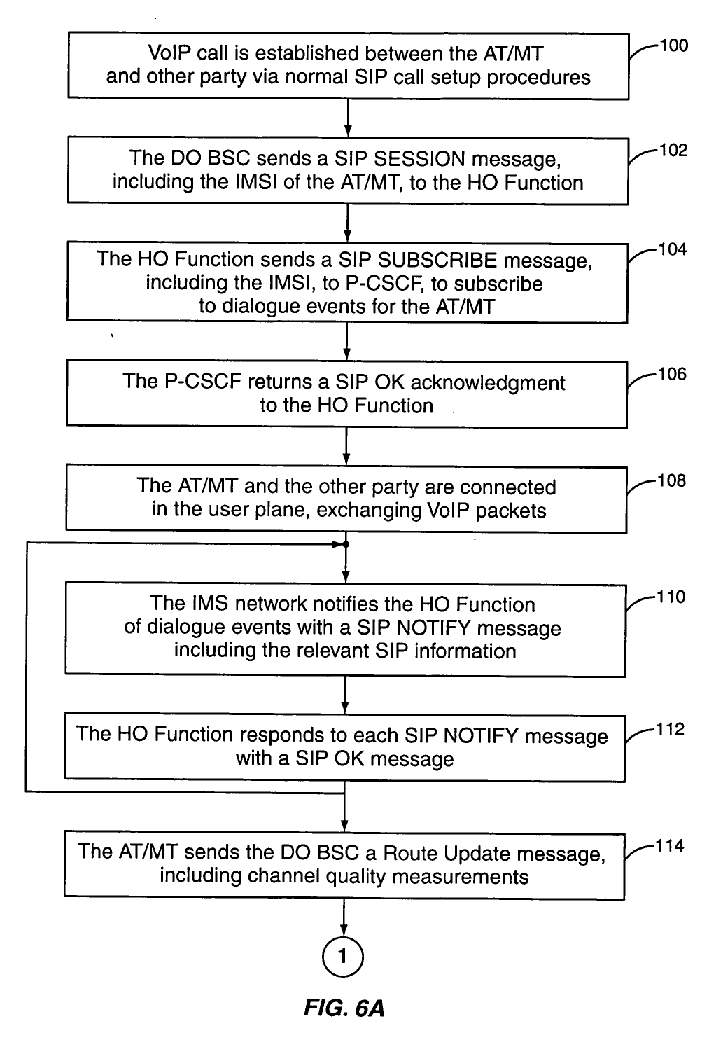

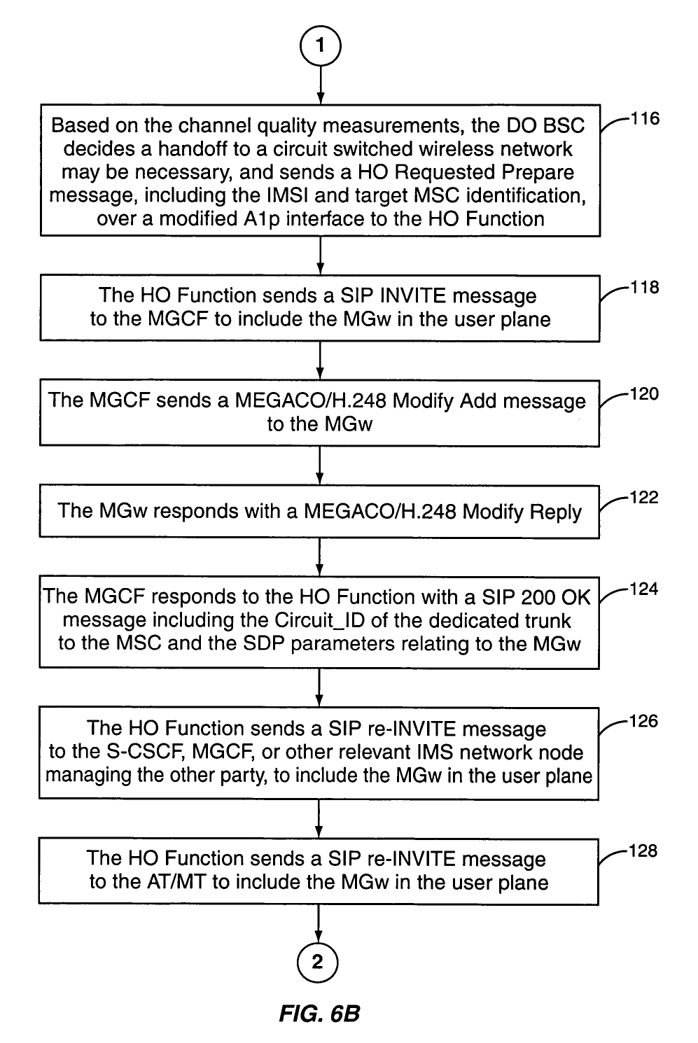

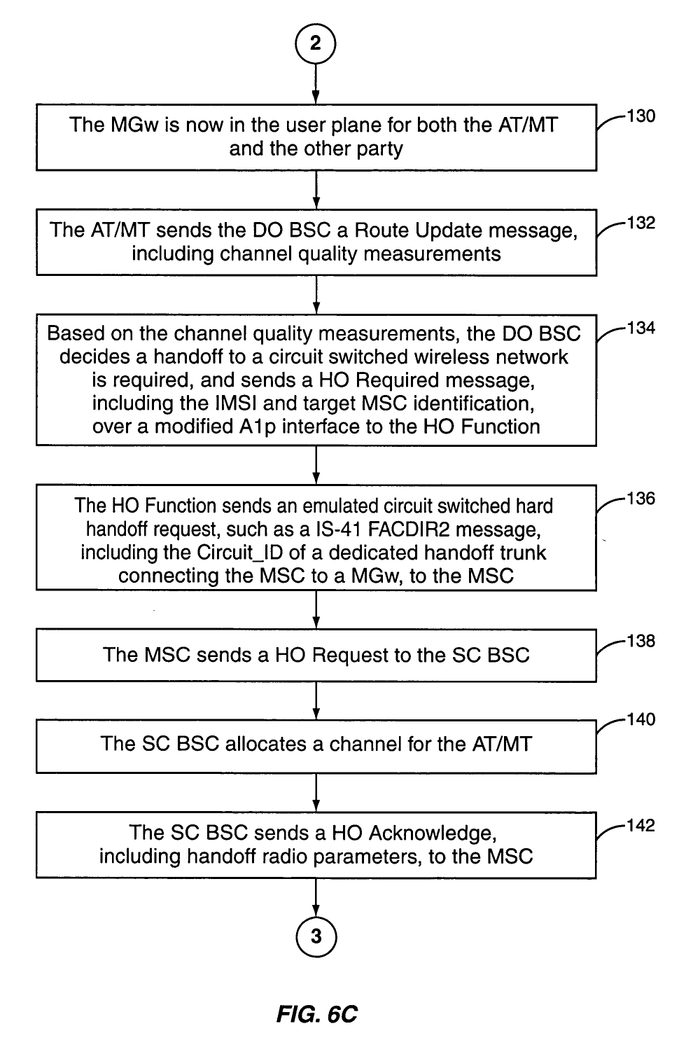

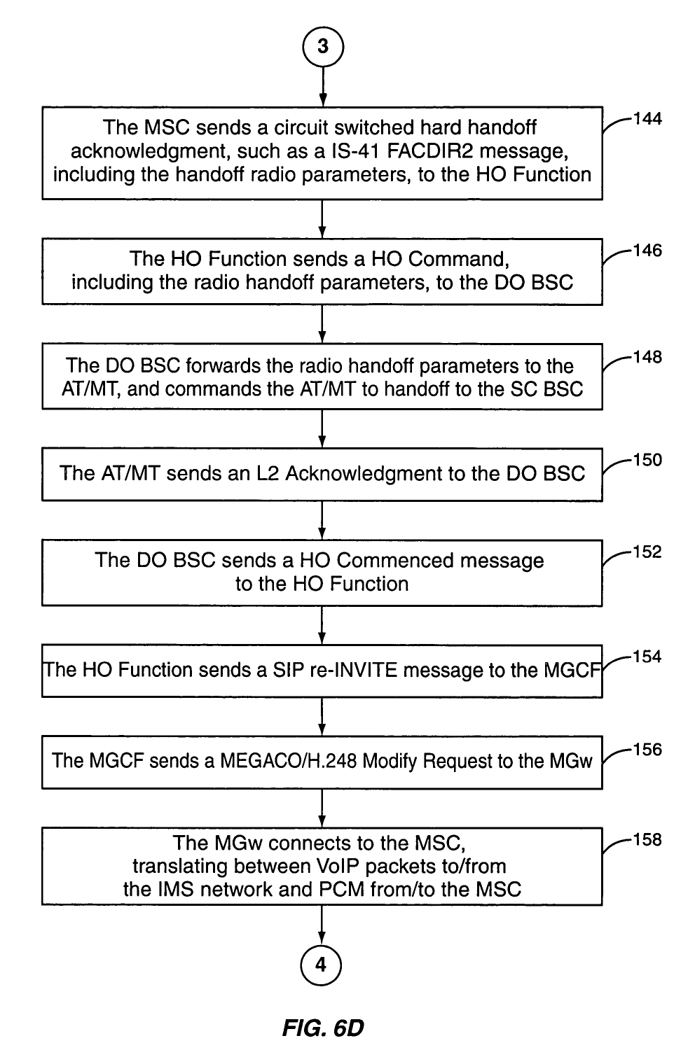

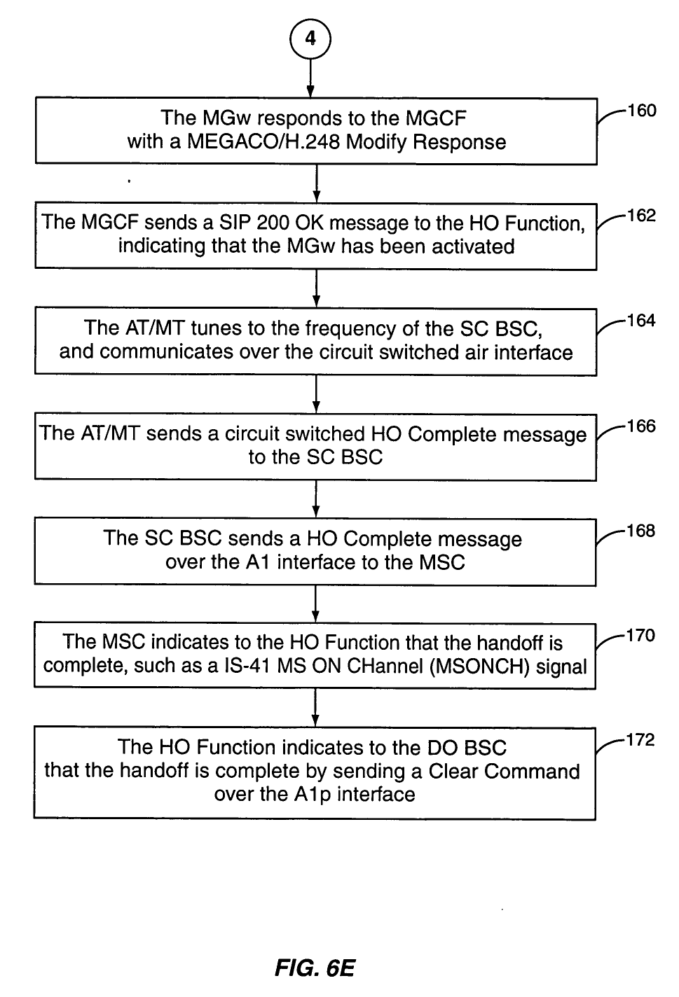

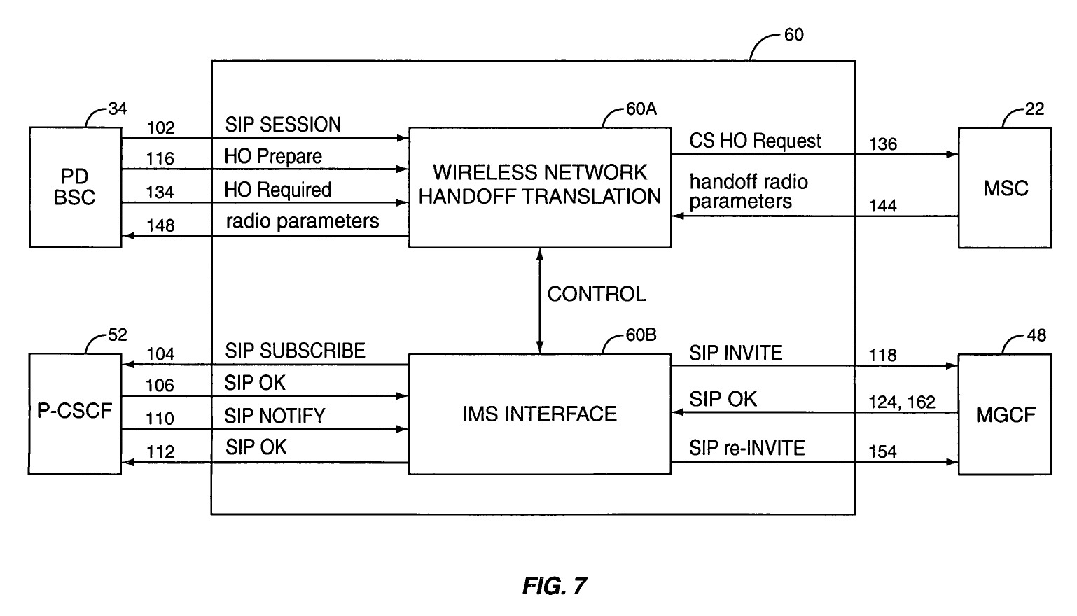

The network signaling related to the handoff according to the present invention is depicted in the call flow diagram of FIG. 6 and in flow diagram form in FIG. 7, wherein the numbering of call events and flow diagram blocks is consistent.

The call between the hybrid AT/MT 62 and the other party—such as AT 84 in IMS network 70—is initially set up according to normal SIP call procedures, which are not further explicated herein (block 100). As soon as the call is set up, the PD BSC 34 sends a SIP SESSION message to HO Function 62 over a modified Alp interface (block 102), identifying the hybrid AT/MT 62 by its International Mobile Subscriber Identity (IMSI). The HO Function 62 then sends a SIP SUBSCRIBE message, including the IMSI, to the local P-CSCF 52 (block 104), which responds with a SIP OK message (block 106).

This subscribes the HO Function 62 to all dialogue events for the hybrid AT/MT 62, as the AT/MT 62 communicates with the other party via VoIP packets over RTP/UDP/IP and the packet data wireless network air interface (block 108). That is, the HO Function 62 will receive a SIP NOTIFY message at every dialog event for the hybrid AT/MT 62 (identified by its IMSI) (block 110). Each SIP NOTIFY is confirmed by the HO Function 62 with a SIP OK message (block 112). The HO Function 62 is thus “aware” of all network aspects of the call (including the URI of the other party) on an ongoing basis. This allows the HO Function 60 to facilitate handoff of the AT/MT 62 without involving the AT/MT's home network.

On a regular basis, the hybrid AT/MT 62 sends a Route Update message, including channel quality measurements (such as, e.g., DRC index), to the PD BSC 34 (block 114). When the PD BSC 34 determines from the quality measurements that a handoff of the hybrid AT/MT 62 may soon be necessary, it sends a HO Required Prepare message over a modified A1p interface to the HO Function 60, alerting the HO Function 60 that a handoff may be imminent (block 116). The HO Required Prepare message includes parameters that identify a target MSC for the handoff, and the IMSI of the hybrid AT/MT 62.

Upon receipt of the HO Required Prepare message, the HO Function 60 generates a SIP INVITE message, and forwards it to a Media Gateway Control Function (MGCF) 48 controlling a Media Gateway (MGw) 50 having a dedicated handoff trunk to the target MSC (block 118). The MGCF 48 adds the MGw 50 via MEGACO/H.248 signaling (blocks 120,122), and responds to the HO Function 60 with a SIP 200 OK message that includes the parameters HO Circuit_ID, identifying the trunk between the MGw 50 and the target MSC 22, and a Session Description Protocol (SDP) containing all relevant multimedia parameters for the MGw 50 (block 124).

The HO Function 60 then brings the MGw 50 into the user plane by issuing a SIP re-INVITE or UPDATE message to the other party, routed to the S-CSCF 74 by normal IMS network routing, based on the URI of the other party (block 126), which in turn routes it to the AT 84. The HO Function 60 additionally sends a re-INVITE or UPDATE message to the hybrid AT/MT 62 via the DO BSC 34 (block 128). This brings the MGw 50 into the IMS user plane for a sending and receiving traffic (block 130).

At some point, the hybrid AT/MT 62 sends a Route Update to the DO BSC 34 (block 132) reporting such poor channel quality that the DO BSC 34 decides a handoff is necessary. The DO BSC 34 send the HO Function 60 a HO Required message over a modified A1p interface (block 134). The HO Required message includes the IMSI and an identification of the target MSC (MSCID). The HO Function 62 generates and sends to the identified target MSC 22 an emulated circuit switched hard handoff request, such as a IS-41 protocol FacilitiesDirective2 (FACDIR2) signal (block 136). The FACDIR2 signal includes a Circuit_ID parameter identifying the dedicated trunk connecting the MSC 22 with the MGw 50 (as received from the MGCF 48 at block 124).

In one embodiment, the PD BSC 34 includes the ability to directly generate the emulated circuit switched hard handoff request (e.g., a IS-41 FACDIR2 signal) with the appropriate parameters, and encapsulate the request in a packet data structure for transmission to the HO Function 60 as the HO Required message. In this embodiment, the HO Function 60 generates the emulated circuit switched hard handoff request by simply decapsulating the request and appending the Circuit_ID parameter, and forwards it to the MSC 22. In another embodiment, the PD BSC 34 sends the HO Function 60 a HO Required message, and the HO Function 60 generates and forwards the emulated circuit switched handoff request (e.g., the IS-41 FACDIR2 signal).

The MSC 22 receives the emulated circuit switched hard handoff request, and queries the CS BSC 24 with a HO Request to obtain handoff radio parameters (block 138). The CS BSC 24 allocates a channel for the handoff (block 140), and provides the handoff radio parameters associated with the allocated channel to the MSC 22 in a HO Acknowledge (block 142). The MSC 22 returns the radio parameters to the HO Function 60, e.g. in a IS-41 FACDIR2 signal, including the handoff radio parameters (block 144).

The HO Function 60 forwards the radio parameters to the PD BSC 34 in a HO Command across the A1p interface (block 148). The PD BSC 34 transmits them to the hybrid AT/MT 62 in a HO Command (block 148). The hybrid AT/MT 62 acknowledges with a L2 Ack (block 150), and may then tune to the frequency band of the CS BSC 24. The PD BSC 34 sends a HO Commenced message to the HO Function (block 152).

The HO Function activates the MGw 50 by sending a SIP re-INVITE message to the MGCF 48 (block 154). The MGCF 48 sends a MEGACO/H.248 Modify Request to the MGw 50 (block 156). This activates the MGw 50, allowing for PCM voice traffic between the MGw 50 and the MSC 22 (block 158). The MGw 50 acknowledges to the MGCF 48 with a MEGACO/H.248 Modify Response (block 160), and the MGCF 48 acknowledges to the HO Function 60 with a SIP 200 OK message (block 162).

The hybrid AT/MT 62 tunes to the frequency of the circuit switched wireless network 20, and establishes communication with the CS BSC 24 over the circuit switched network air interface (block 164). The hybrid AT/MT 62 sends a HO Complete message to the CS BSC 24 (block 166). The CS BSC 24 forwards the HO Complete message to the MSC 22 (block 168), and the MSC 22 informs the HO Function 60 that to the handoff is complete, such as by a IS-41 Mobile Station ON CHannel (MSONCH) signal (block 170). The HO Function 60 sends a Clear Command to the PD BSC 34, indicating to the PD BSC 34 that the handoff was completed successfully (block 172).

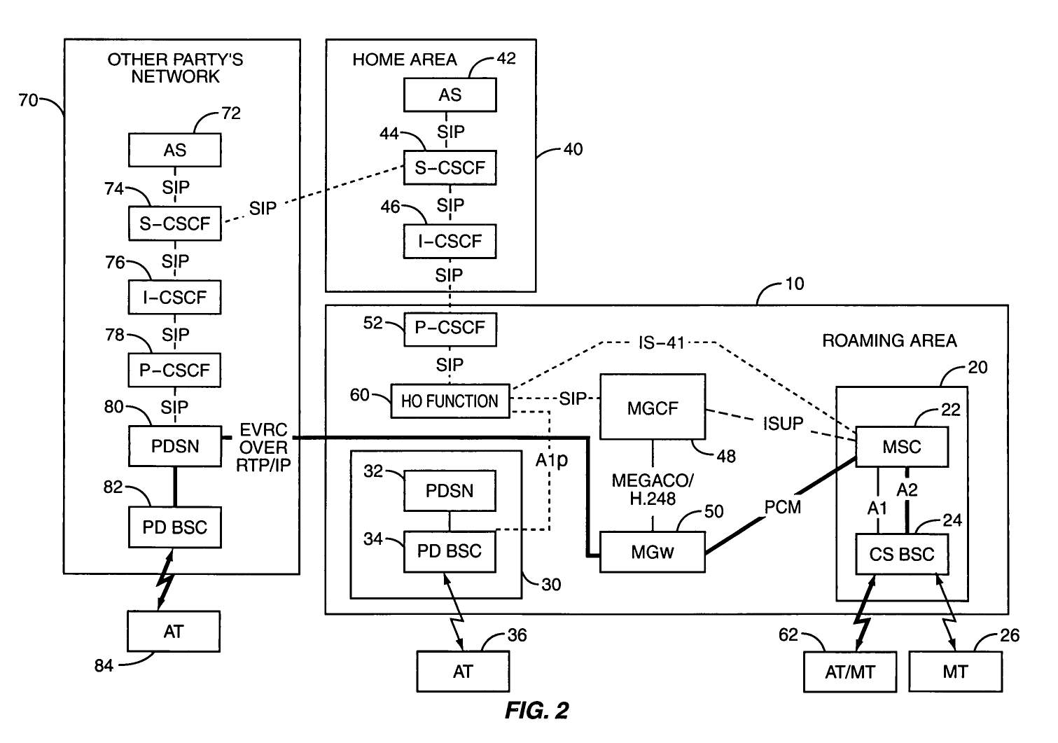

FIG. 2 depicts the networks after the handoff is complete. The heavy solid lines show the flow of the voice call: from the AT 84, through the PD BSC 82, and to the PDSN 80 of the other party's IMS network 70. Coded voice packets are then transmitted via RTP or IP to the MGw 50. The MGW 50 translates the coded voice data to the 64kbs Pulse Code Modulated (PCM) format of the circuit switched wireless network 20 backhaul, and transmits it to the MSC 22 over the dedicated handoff trunk. The MSC 22 sends the voice signals to the CS BSC 24 over an A2 interface, which transmits them to the hybrid AT/MT 62 on a dedicated channel. Voice signals in the opposite direction follow the reverse path.

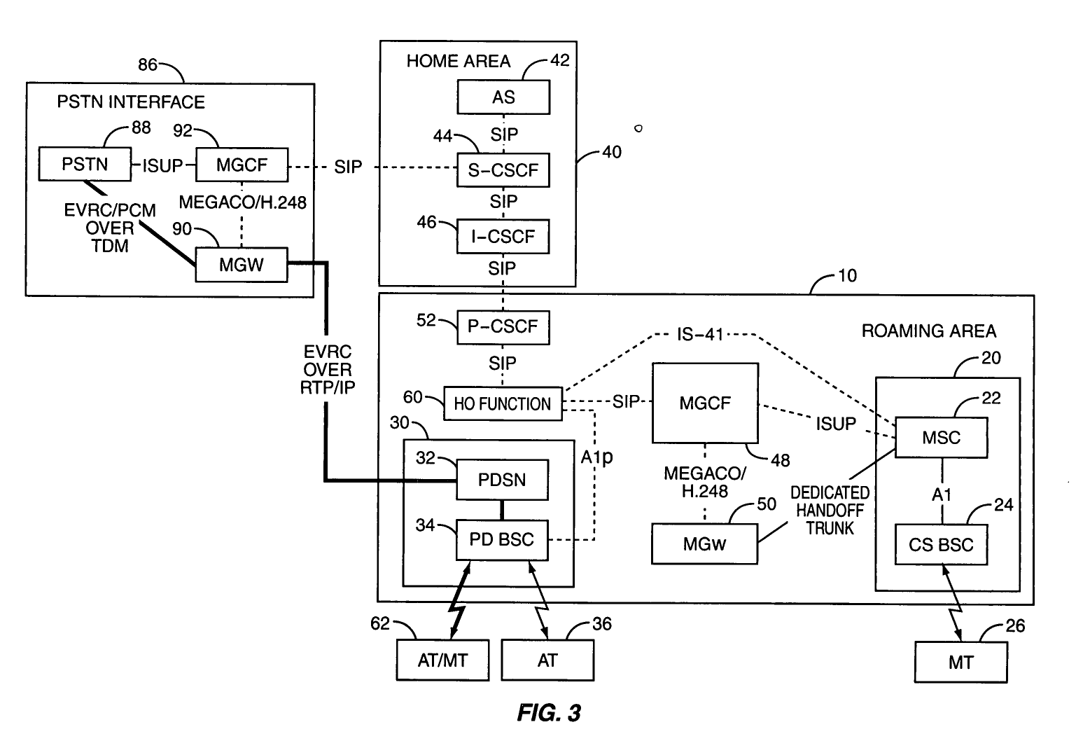

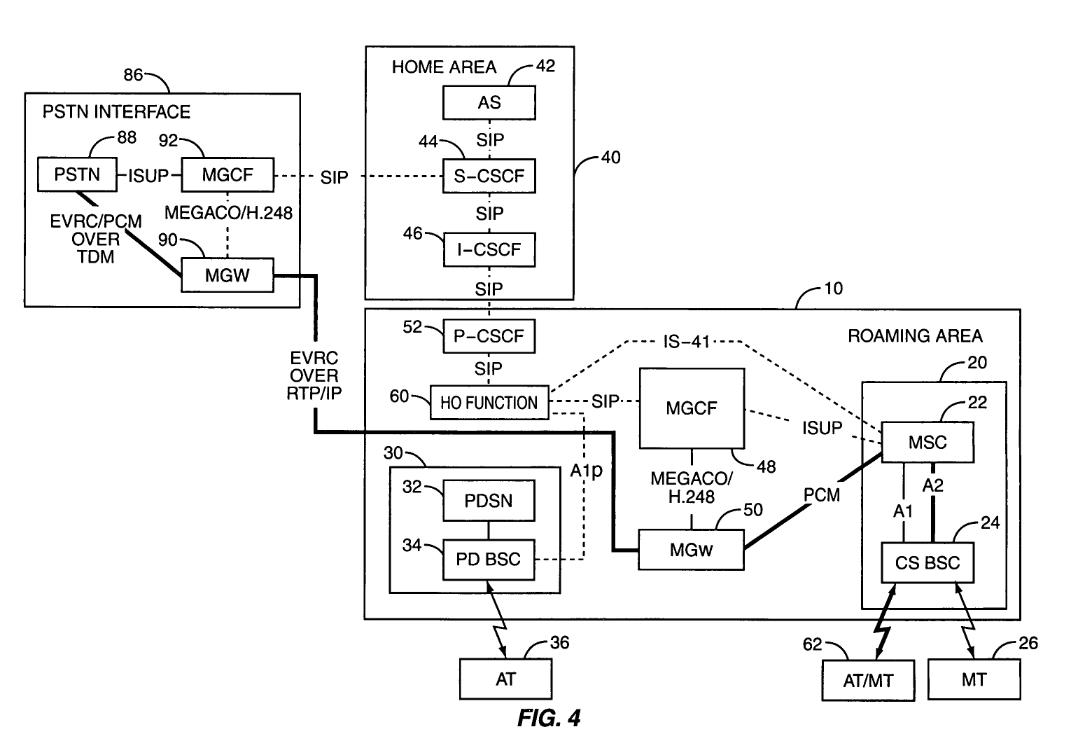

FIG. 3 depicts a roaming AT/MT 62 in a VoIP call with a party on the Public Switched Telephone Network (PSTN) 88. A PSTN interface network 86 includes a Media Gateway Control Function (MGCF) 92 controlling a Media Gateway (MGw) 90 that is connected to the PSTN 88 over a time division multiplexed (TDM) link. The MGw 90 converts voice signals from EVRC or PCM on TDM to coded voice data packets and transmits them over an RTP or IP link to the PDSN 32. The PDSN 32 sends the voice data packets to the PD BSC 34, which transmits them to the hybrid AT/MT 62. VoIP packets in the opposite direction follow the reverse path.

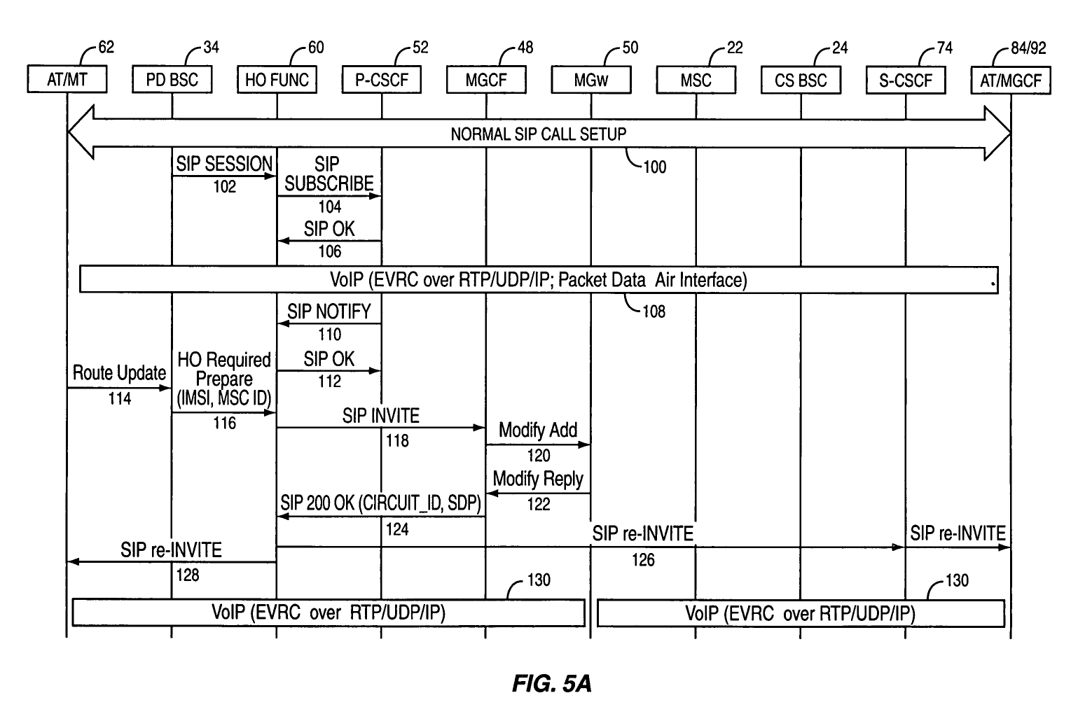

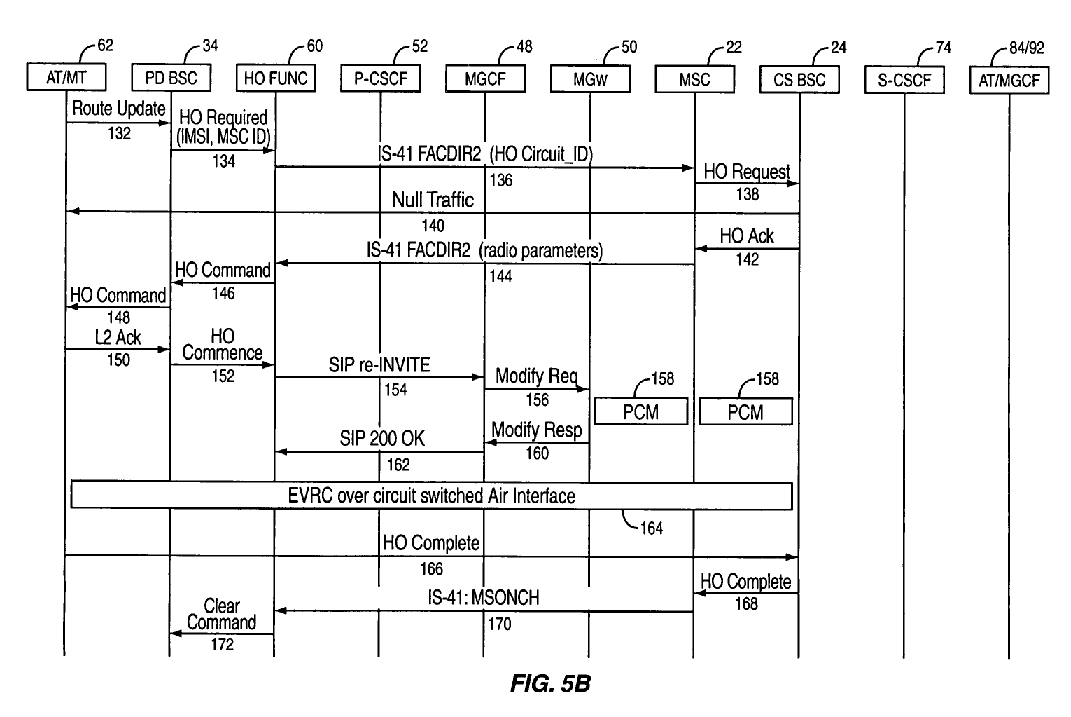

FIG. 6 depicts the call of the FIG. 5 following a handoff of the hybrid AT/MT 62 from the packet data wireless network 30 to the circuit switched wireless network 20, facilitated by network signaling of the HO Function 60 as described above. As depicted by heavy lines, voice signals travel from a telephone in the PSTN 88 and are translated by the MGw 90 into coded voice data packets. The packet data is forwarded to the MGw 50, which translates it to PCM and sends it to the MSC 22 over a dedicated trunk. The MSC 22 forwards the voice signals over an A2 link to the CS BSC 24, which transmits them to the hybrid AT/MT 62 over a dedicated channel. Voice signals in the opposite direction follow the reverse path.

Inventive network elements of the present invention include: the HO Function 60 as described above; in one embodiment a modified PD BSC 34 operative to create and packet-encapsulate an emulated circuit switched hard handoff request; a modified IS-2001 A1p interface between the PD BSC 34 and the HO Function 60 including the IMSI parameter, the SIP SESSION message 102, and the HO Required Prepare message 116; and a hybrid AT/MT 66 with the ability to handle sending and receiving circuit switched handoff messages on the packet data bearer; as well as the inventive methods of network operation described herein.

A functional block diagram of one embodiment of the HO Function 60 is depicted in FIG. 7. The HO Function 60 comprises a wireless network handoff translation module 60A and a IMS interface module 60B, with control signaling between the modules 60A, 60B.

The wireless network handoff translation module 60A is connected, on the packet data side, to the PD BSC 34. On the circuit switched side, the wireless network handoff translation module 60A is connected to the MSC 22. The wireless network handoff translation module 60A receives a SIP SESSION request 102, HO Required Prepare 114 and HO Required 134 messages (see FIGS. 5 and 6 for signal flows and descriptions) from the PD BSC 34, and outputs an emulated circuit switched hard handoff request 136 to the MSC 22. The wireless network handoff translation module 60A receives handoff radio parameters 144 from the MSC 22, and outputs the handoff radio parameters 148 to the PD BSC 34.

The IMS interface 60B generates and outputs a SIP SUBSCRIBE message 104 to the P-CSCF 52 to subscribe to the dialogue events for the hybrid AT/MT 62 (in response to the SIP SESSION request 102 received from the PD BSC 34). The P-CSCF 52 sends a SIP 200 OK message 106 to the IMS interface 60B in response, and additionally may send one or more SIP NOTIFY messages 110 to alert the IMS interface 60B of dialogue events. IMS interface 60B acknowledges each NOTIFY 110 with a SIP OK message 112. In response to the wireless network handoff translation module 60A, the IMS interface 60B generates a SIP INVITE message 118 to add the MGw 50 to the user plane, and a SIP re-INVITE messages 154 to activate the MGw 50. The IMS interface 60B receives SIP OK acknowledgement messages 124, 162, respectively, in response. Note that in any given implementation, the HO Function 60 and MGCF 48 may be combined and/or co-located.

With the inventive network nodes and signaling methods of one or more embodiments of the present invention, a hybrid AT/MT 62 may be handed off from a packet data wireless network to a circuit switched wireless network while engaged in a call with a party through an IMS network, in a manner than fully complies with the IMS architectural principles in 3GPP/3GPP2. In particular, the network signaling is distributed; the home network of the AT/MT 62 being handed off does not need to be involved in the handoff. By having the HO Function 60 subscribe to all dialogue events for each call of each of its associated PD BSCs 34, any call may be handed off to a circuit switched wireless network by signaling within the roaming network. The inventive system and method enables distributed management of session information in a packet data Radio Access Network (RAN) while enabling one packet data RAN to contain thousands of Radio Base Stations.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. A method of handing off a roaming, hybrid Access Terminal/Mobile Terminal (AT/MT), from a packet data wireless network to a circuit switched wireless network, comprising:
monitoring the call state of the hybrid AT/MT within the roaming network; and
handing off the hybrid AT/MT from the packet data wireless network to the circuit switched wireless network without support from the home network of the hybrid AT/MT.

2. The method of claim 1 wherein monitoring the call state of the hybrid AT/MT comprises Session Initiation Protocol (SIP) based monitoring of dialogue events related to the hybrid AT/MT.

3. The method of claim 2 wherein SIP based monitoring of dialogue events related to the hybrid AT/MT comprises sending a SIP SUBSCRIBE message to a Proxy-Call Session Control Function having SIP connectivity to the home network of the hybrid AT/MT.

4. The method of claim 3 wherein the SIP SUBSRIBE message is sent in response to an event triggered at call setup.

5. The method of claim 1 further comprising altering the user plane of a call from connection to a Packet Data Services Node (PDSN) in the packet data wireless network to connection to a media gateway that is connected to a Mobile Switching Center (MSC) in the circuit switched wireless network.

6. The method of claim 5 further comprising sending an emulated circuit switched hard handoff request to the MSC and receiving handoff radio parameters from the MSC.

7. A method of facilitating the handoff of a hybrid Access Termina/Mobile Terminal (AT/MT), engaged in a call with another party through an IP Multimedia Subsystem (IMS) network, from a packet data wireless network to a circuit switched wireless network, comprising:
receiving a handoff indication from the packet data network;
adding to the IMS user plane between the hybrid AT/MT and other party a Media Gateway (MGw) having a dedicated connection to a Mobile Switching Center (MSC) in the circuit switched wireless network;
sending an emulated hard handoff request to the MSC, identifying the MGw connection;
receiving radio parameters for the circuit switched wireless network from the MSC;
forwarding the circuit switched wireless network radio parameters in a handoff command to the hybrid AT/MT; and
directing the other party to connect to the MGw.

8. The method of claim 7 further comprising subscribing at call setup to all IMS dialog events related to the hybrid AT/MT.

9. The method of claim 7 wherein the MGw translates media formats between the IMS network and the circuit-switched wireless network.

10. The method of claim 7 wherein sending the emulated hard handoff request to the MSC identifying the MGw connection comprises sending to the MSC an IS-41 FACDIR2 signal including a CircuitID parameter identifying the dedicated handoff trunk connected to the MGw.

11. The method of claim 7 wherein the packet data wireless network is a 1×EV-DO network.

12. A Handoff (HO) Function with signaling connections to a packet data wireless network, a circuit switched wireless network, and an IP Multimedia Subsystem (IMS) network, the HO Function operative to facilitate the handoff of a hybrid Access Terminal/Mobile Terminal (AT/MT) from the packet data wireless network to the circuit switched wireless network, comprising:
a IMS interface module subscribing to events for a call, and exchanging SIP messages with the IMS network to alter the IMS network user plane connectivity; and
a wireless network handoff translation module receiving a handoff request from, and outputting circuit switched radio parameters to, the packet data wireless network, and outputting an emulated circuit switched handoff request to, and receiving handoff radio parameters from, the circuit switched wireless network.

13. The HO Function of claim 12 wherein the handoff request comprises an emulated circuit switched handoff request encapsulated in a packet data structure, and wherein the wireless network handoff translation module is operative to decapsulate the circuit switched handoff request and forward it to the MGCF.

14. The HO Function of claim 12 wherein the wireless network handoff translation module is operative to generate and output an emulated circuit switched handoff request in response to the handoff request from the packet data wireless network.

15. The HO Function of claim 12 further comprising signaling connections to a Media Gateway Control Function (MGCF) controlling a Media Gateway (MGw) connected to the circuit switched wireless network.

16. A communication network operative to hand off a hybrid Access Terminal/Mobile Terminal (AT/MT) from a packet data wireless network to a circuit switched wireless network during a call with another party, comprising:
a Media Gateway (MGw) connected to the circuit switched wireless network via a dedicated handoff trunk and connected to one or more packet data networks by a packet data link, the MGw operative to translate media between packet data and circuit switched formats under the control of a Media Gateway Control Function (MGCF); and
a Handoff (HO) Function having signaling connections to the MGCF, the packet data wireless network, the circuit switched wireless network, and at least one IP Multimedia Subsystem (IMS) network and operative to subscribe to events for a call in the packet data wireless network.

17. The communication network of claim 16 wherein the HO Function is operative to receive a handoff indication from the packet data wireless network;
generate an emulated circuit switched handoff request and output the emulated circuit switched handoff request to the circuit switched wireless network;
receive handoff radio parameters from the circuit switched a wireless network; and
forward the handoff radio parameters to the packet data wireless network.

18. The communication network of claim 17 wherein the handoff indication comprises a packet-encapsulated emulated circuit switched handoff request, and wherein the HO Function is operative to decapsulate the emulated circuit switched handoff request and output it to the circuit switched wireless network.

19. The communication network of claim 17 wherein the HO Function is operative to generate the emulated circuit switched handoff request in response to the handoff indication.

20. The communication network of claim 16 wherein the HO Function exchanges SIP messages with the MGCF so as to establish a media path between the hybrid AT/MT and the MGw following the handoff of the hybrid AT/MT from the packet data wireless network to the circuit switched wireless network.

21. The communication network of claim 16 wherein the HO Function exchanges SIP messages with the IMS network so as to redirect call flow from connection to the packet data wireless network to connection to the MGw.
